(19) United States
(12) Patent Application Publication
(10) Pub. No.: US 2020/0264750 A1
(43) Pub. Date: Aug. 20, 2020

(54) METHOD FOR DISPLAYING VISUAL OBJECT REGARDING CONTENTS AND ELECTRONIC DEVICE THEREOF

(71) Applicant: Samsung Electronics Co., Ltd., Suwon-si (KR)

(72) Inventors: Sangmin Park, Suwon-si (KR); Kyungtae Kim, Suwon-si (KR)

(21) Appl. No.: 16/795,424

(22) Filed: Feb. 19, 2020

(30) Foreign Application Priority Data
Feb. 19, 2019 (KR) 10-2019-0019213

(51) Int. Cl. G06F 3/0485; G06F 3/0481; G06F 3/0488; G06F 40/289

(52) U.S. Cl. CPC G06F 3/0485; G06F 40/289; G06F 3/04883; G06F 3/0481

(57) ABSTRACT

Various embodiments of the disclosure relate to an apparatus and a method for displaying a visual object related to a content. An electronic device according to various embodiments includes a display and a processor. The processor is configured to: display a first content from among a plurality of contents within a user interface in the display; identify a user input performed within the user interface; in response to the user input being identified, display a second content distinct from the at least one content displayed; identify information related to the first content and the second content; and, in response to the information being identified, display a visual object corresponding to the identified information within the user interface.

### CROSS-REFERENCE TO RELATED APPLICATION

This application is based on and claims priority under 35 U.S.C. § 119 to Korean Patent Application No. 10-2019-0019213 filed on Feb. 19, 2019 in the Korean Intellectual Property Office, the disclosure of which is herein incorporated by reference in its entirety.

### BACKGROUND

### 1. Field

Various embodiments relate to a method for displaying a visual object related to a content and an electronic device supporting the same.

### 2. Description of Related Art

Electronic devices support various functions through various applications. Electronic devices provide a messenger function and a file management function by using various applications. An electronic device may display a plurality of contents on a screen while executing various functions.

The above information is presented as background information only to assist with an understanding of the disclosure. No determination has been made, and no assertion is made, as to whether any of the above might be applicable as prior art with regard to the disclosure.

### SUMMARY

When a plurality of contents are listed and displayed in an electronic device, a user of the electronic device may have difficulty in searching a content that the user wishes to find. There is a demand for a solution for easily searching by providing summary information or keyword information of contents to a user of an electronic device.

The technical object to be achieved by the disclosure is not limited to that mentioned above, and other technical objects that are not mentioned above may be clearly understood to those skilled in the art based on the description provided below.

An electronic device according to various embodiments may include a display and a processor, and the processor may be configured to: display a first content from among a plurality of contents within a user interface in the display; identify a user input performed within the user interface; in response to the user input being identified, display a second content distinct from the at least one content displayed; identify information related to the first content and the second content; and, in response to the information being identified, display a visual object corresponding to the identified information within the user interface.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device in a network environment according to various embodiments;

FIG. 2 is a view illustrating an example of a functional configuration of an electronic device according to various embodiments;

FIG. 3A illustrates a flowchart to explain an example of an electronic device for displaying visual objects indicating information related to a first content and a second content according to various embodiments;

FIG. 3B illustrates a flowchart to explain an example of the electronic device for displaying a part of a content according to various embodiments;

FIG. 4A is a view illustrating an example of a user interface of an electronic device according to various embodiments;

FIG. 4B illustrates a view to explain a range for obtaining information related to a content according to a user input in the electronic device according to various embodiments;

FIG. 5 is a view illustrating an example of an operation of identifying information related to a first content and a second content in an electronic device according to various embodiments;

FIG. 6 is a view illustrating another example of a user interface of an electronic device according to various embodiments;

FIG. 7 illustrates a flowchart for adjusting a scroll speed according to importance of a content in an electronic device according to various embodiments;

FIG. 8 is a view illustrating another example of an operation of adjusting a scroll speed according to importance of a content according to various embodiments; and

FIG. 9 is a view illustrating still another example of a user interface of an electronic device according to various embodiments.

### DETAILED DESCRIPTION

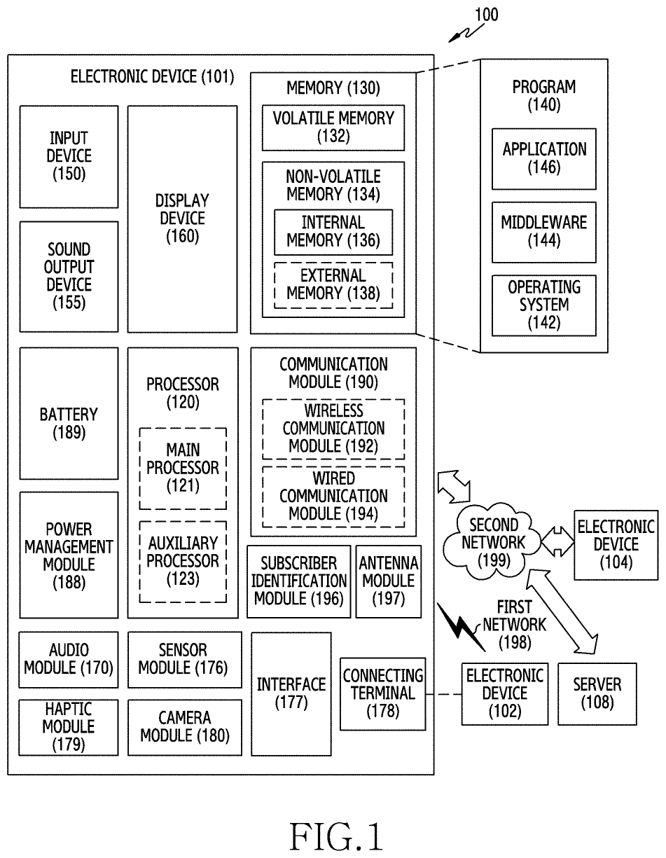

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

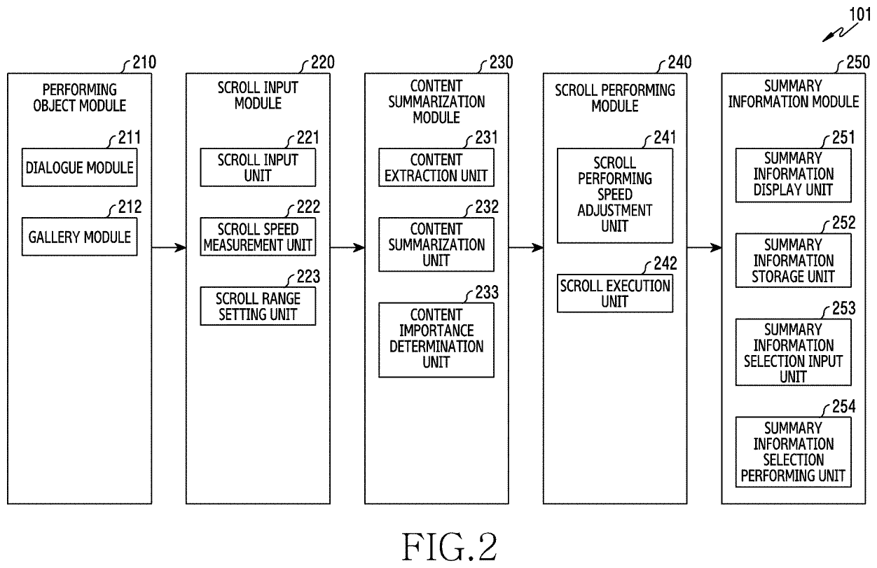

FIG. 2 illustrates an example of a functional configuration of an electronic device according to various embodiments.

Referring to FIG. 2, the electronic device (for example, the electronic device 101 of FIG. 1) may further include a performing object module 210, a scroll input module 220, a content summarization module 230, a scroll performing module 240, or a summary information module 250. The components illustrated in FIG. 2 may be implemented as individual components or may be embedded and implemented as parts of the components shown in FIG. 1 (for example, the processor 120 and/or the memory 130 of FIG. 1). According to an embodiment, the electronic device 101 may include an electronic device (for example, a smartphone) which may not display all of a plurality of contents on one screen.

According to an embodiment, the performing object module 210 may include an application for displaying a plurality of contents within the electronic device 101. According to an embodiment, the performing object module 210 may include a dialogue module 211 or a gallery module 212. In addition, the performing object module 210 may include an application or some functions of the application for displaying a part of the plurality of contents on the screen according to a user input when the plurality of contents cannot be displayed on one screen in the electronic device 101.

According to an embodiment, the performing object module 210 may include the dialogue module 211 for performing a conversation between users, and the gallery module 212 for displaying a plurality of images within the electronic device 101. According to an embodiment, the dialogue module 211 may include a text message application, a chatting application, or a conversation interface within the application. According to an embodiment, the gallery module 212 may include an application for displaying a plurality of images (or multimedia contents) stored in the electronic device 101. For example, the gallery module 212 may include a photo viewer, an image viewer, a video replay application, or an image thumbnail screen in the application.

According to an embodiment, the performing object module 210 may display at least a part of a scrollable content through a display device (for example, the display device 160 of FIG. 1) of the electronic device 101. For example, the performing object module 210 may display a part of a chatting dialogue through the display device 160.

According to an embodiment, the scroll input module 220 may receive a user input of the electronic device 101. The scroll input module 220 may parse the received user input and transmit the parsed information to the scroll performing module 240. According to an embodiment, the scroll input module 220 may include a scroll input unit 221, a scroll speed measurement unit 222, or a scroll range setting unit 223.

According to an embodiment, the scroll input unit 221 may receive a user input from the input device 150 of the electronic device 101. The scroll input unit 221 may determine whether the input device (for example, the input device 150 of FIG. 1) of the electronic device 101 receives a user input. According to an embodiment, the user input may include a scroll input, and for example, may include at least one of a swipe up/down input, a touch and drag input, a voice input, a gesture input, a contactless scroll input, a scroll through a pen, an input method through pupils. The user input may include a scroll input of various methods on a certain position of the input device 150 and a scroll input of a simple touch or touch and drag method on an object (for example, a scroll bar) displayed on the display device 160.

According to an embodiment, the scroll input unit 221 may identify that the user input starts from a first position of the display of the electronic device 101. The scroll input unit 221 may identify that the user input ends at a second position of the display of the electronic device 101. According to an embodiment, when a plurality of user inputs occur, the scroll input unit 221 may identify whether the user inputs continuously occur. The scroll input unit 221 may identify a time interval between the plurality of user inputs. For example, the scroll input unit 221 may identify that the user of the electronic device 101 iteratively performs a scroll input on the display of the electronic device 101. The processor 120 may identify a time interval between the scroll inputs.

According to an embodiment, the scroll speed measurement unit 222 may measure a speed of the user input (for example, the scroll input or drag input). According to an embodiment, in response to the user input starting from the first position of the display of the electronic device 101 and ending at the second position, the scroll speed measurement unit 222 may identify the speed of the user input. According to an embodiment, the scroll speed measurement unit 222 may identify whether the speed of the user input is faster or slower than a designated speed. The scroll speed measurement unit 222 may transmit the identified information to the scroll range setting unit 223.

According to an embodiment, the scroll range setting unit 223 may receive information regarding the speed of the user input from the scroll speed measurement unit 222. The scroll range setting unit 223 may determine a range to be displayed from a first content to a second content displayed within the user interface (UI) in the display of the electronic device 101, based on the speed of the user input. For example, when a part of the dialogue (or a conversation content) is displayed within the user interface in the electronic device 101, the scroll range setting unit 223 may move more contents as the speed of the user input is faster and may determine the second content to be displayed within the user interface of the electronic device 101. In another example, the scroll range setting unit 223 may move less contents as the speed of the user input is slower and may determine the second content to be displayed within the user interface.

According to an embodiment, the scroll range setting unit 223 may determine the range of the content to be displayed in the user interface of the electronic device 101, based on the speed of the user input.

According to an embodiment, the content summarization module 230 may include a content extraction unit 231, a content summarization unit 232, or a content importance determination unit 233. According to an embodiment, the content summarization module 230 may identify information related to the first content and the second content, based on the first content and the second content. According to an embodiment, the content summarization module 230 may identify information included in the first content and the second content in common. According to an embodiment, the content summarization module 230 may determine or extract a word, a phrase, a sentence, and/or a symbol associated with the content. The content summarization module 230 may identify information included in common from the extracted word, phrase, sentence, and/or symbol associated with the first content and the second content. According to an embodiment, the content summarization module may include a keyword spotting algorithm.

According to an embodiment, the content extraction unit 231 may extract a relationship between information included in the first content and information included in the second content. According to an embodiment, the content extraction unit 231 may identify meta data of the first content and the second content. The content extraction unit 231 may extract a relationship between the meta data of the first content and the meta data of the second content. According to an embodiment, when the first content and the second content are images, the content extraction unit 231 may extract a relationship between an object included in the first content and an object included in the second content.

According to an embodiment, the content extraction unit 231 may identify information included in the content. The information included in the content may include information regarding what may define a person, a place, a thing, an event, or a concept. For example, when the content is a text, the content extraction unit 231 may identify a subject or an object corresponding to a noun as information included in the content. According to an embodiment, when the first content and the second content are parts of a dialogue, the content extraction unit 231 may extract a relationship between a word (or a keyword) included in the first content and a word (or a keyword) included in the second content. For example, when the first contents is a conversation content such as “Let's go riding a bike!” and the second content is a conversation content such as “Let's meet at 2 o'clock,” the content extraction unit 231 may extract “bike” from the first content and “2 o'clock” from the second content. The content extraction unit 231 may identify that the “bike” is an object of a behavior and “2 o'clock” is a time. According to an embodiment, the content extraction unit 231 may transmit the identified information to the content summarization unit 232.

According to an embodiment, the content extraction unit 231 may extract a relationship between information included in the first content and information included in the second content. According to an embodiment, the relationship between the information included in the first content and the information included in the second content may include an inclusion relationship in position between things. According to an embodiment, the relationship between the information included in the first content and the information included in the second content may include a family relationship or a friendship between persons.

According to an embodiment, the content summarization unit 232 may receive the identified information from the content extraction unit 231. The content summarization unit 232 may combine the identified information. For example, the content summarization unit 232 may combine the identified information like “bike” and “2 o'clock” into “riding a bike at 2 o'clock.”

According to an embodiment, the content importance determination unit 233 may identify importance of the content through an importance determination algorithm. According to an embodiment, the content importance determination unit 233 may perform the importance determination algorithm. According to an embodiment, the importance determination algorithm may include a part of a topic detection algorithm or a text summarization algorithm. According to an embodiment, the content importance determination unit 233 may classify a plurality of contents by importance. According to an embodiment, the content importance determination unit 233 may identify importance of a plurality of contents included in a dialogue. For example, the content importance determination unit 233 may set importance of a content related to a usual conversation of a dialogue to be low. In another example, the content importance determination unit 233 may set importance of a content related to determination of an appointment place of a dialogue to be high.

According to an embodiment, the scroll performing module 240 may perform overall operations related to a scroll speed. According to an embodiment, the scroll performing module 240 may include a scroll performing speed adjustment unit 241 or a scroll execution unit 242.

According to an embodiment, the scroll performing speed adjustment unit 241 may receive information regarding the importance of the plurality of contents from the content importance determination unit 233. The scroll performing speed adjustment unit 241 may determine a scroll performing speed based on the importance of the plurality of contents. For example, the scroll performing speed adjustment unit 241 may determine a scroll speed of a content of high importance to be low. In another example, the scroll performing speed adjustment unit 241 may determine a scroll speed of a content of low importance to be high. According to an embodiment, the scroll performing speed adjustment unit 241 may transmit information regarding the determined scroll performing speed to the scroll execution unit 242.

According to an embodiment, the scroll execution unit 242 may receive the information regarding the scroll performing speed from the scroll performing speed adjustment unit 241. The scroll execution unit 242 may adjust the scroll speed of each content in the electronic device 101, based on the scroll performing speed determined at the scroll performing speed adjustment unit 241. For example, when the same user input is received, the scroll execution unit 242 may scroll fast on a content of low importance, and may scroll slow on a content of high importance.

According to an embodiment, the summary information module 250 may include a summary information display unit 251, a summary information storage unit 252, a summary information selection input unit 253, or a summary information selection performing unit 254.

According to an embodiment, the summary information display unit 251 may display the word, phrase, sentence, and/or symbol associated with the content, which is determined through the content summarization module 230, within the user interface.

According to an embodiment, the summary information display unit 251 may display the information related to the first content and the second content in the form of a visual object by overlapping with at least one content while the contents are displayed. The information related to the first content and the second content may include summary information, keyword information. According to an embodiment, the summary information display unit 251 may display the information related to the first content and the second content within the user interface in the form of a pop-up window in response to a user input. According to an embodiment, in response to the user input being held, the summary information display unit 251 may display the information related to the first content and the second content within the user interface in the form of a pop-up window. According to an embodiment, the summary information display unit 251 may display a visual object indicating the information related to the first content and the second content by overlapping with the plurality of contents while at least a part of the plurality of contents is displayed. According to an embodiment, the summary information display unit 251 may maintain the visual object indicating the information related to the first content and the second content for a designated time. The summary information display unit 251 may maintain the visual object indicating the information related to the first content and the second content for the designated time, and then may fade out. According to an embodiment, the summary information display unit 251 may display the visual object indicating the information related to the first content and the second content in response to the user input being held.

According to an embodiment, the summary information storage unit 252 may store the information (for example, summary information, keyword information) related to the first content and the second content. The summary information storage unit 252 may store the information related to the first content and the second content, based on the information related to the first content and the second content being obtained. The summary information storage unit 252 may store information related to a third content and a fourth content, based on the information related to the third content and the fourth content being obtained. According to an embodiment, the summary information storage unit 252 may store information related to the first content and the fourth content. For example, the summary information storage unit 252 may store information related to a plurality of contents included in a dialogue. The dialogue may include a first conversation (or log), a second conversation (or log), a third conversation (or log), and a fourth conversation (or log) in sequence. The summary information storage unit 252 may store information (summary information, keyword information) related to the first conversation and the second conversation. The summary information storage unit 252 may store information (summary information, keyword information) related to the first conversation and the third conversation. The summary information storage unit 252 may store information (summary information, keyword information) related to the first conversation and the fourth conversation. The summary information storage unit 252 may store information (summary information, keyword information) related to the second conversation and the third conversation. The summary information storage unit 252 may store information (summary information, keyword information) related to the second conversation and the fourth conversation. The summary information storage unit 252 may store information (summary information, keyword information) related to the third conversation and the fourth conversation. According to an embodiment, the summary information storage unit 252 may transmit the stored information to the summary information display unit 251.

According to an embodiment, the summary information selection input unit 253 may receive an input of selecting the visual object indicating the information related to the first content and the second content from the user. The summary information selection performing unit 254 may display the first content or the second content, based on the user input of selecting the visual object indicating the information related to the first content and the second content being received. For example, the summary information selection performing unit 254 may display the first content or the second content based on the input of selecting the visual object indicating the information related to the first content and the second content, while displaying the third content on the display.

The processor 120 may control overall operations of the electronic device 101 although this is not illustrated. The processor 120 may be operatively connected with other components in the electronic device 101, such as the performing object module 210, the scroll input module 220, the content summarization module 230, the scroll performing module 240, or the summary information module 250, in order to control the overall operations of the electronic device 101.

According to an embodiment, the processor 120 may receive commands of the other components (for example, the performing object module 210, the scroll input module 220, the content summarization module 230, the scroll performing module 240, or the summary information module 250). The processor 120 may interpret a received command. The processor 120 may compute and may process data according to the interpreted command. The processor 120 may be implemented by software, may be implemented by hardware such as a chip, a circuitry, or the like or may be implemented by a set of software and hardware. The processor 120 may be one processor or a set of a plurality of processors.

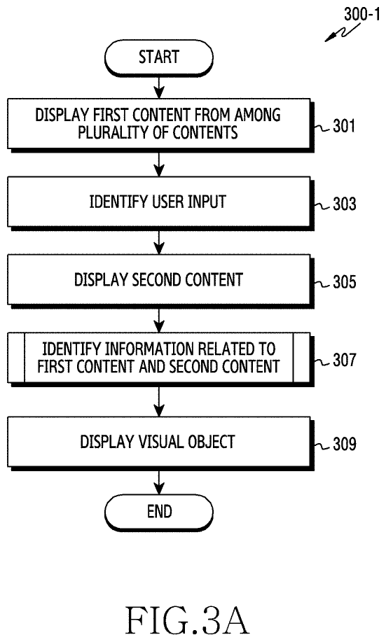

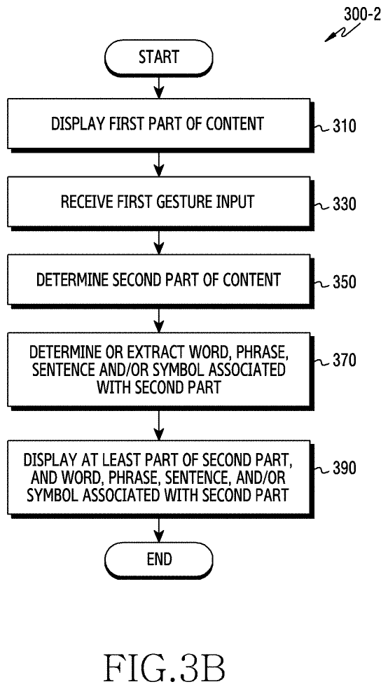

According to various embodiments, the processor 120 may interpret a message, data, a command, or a signal received from the performing object module 210, the scroll input module 220, the content summarization module 230, the scroll performing module 240, or the summary information module 250. The processor 120 may process the message, data, command, or signal received from the performing object module 210, the scroll input module 220, the content summarization module 230, the scroll performing module 240, or the summary information module 250. The processor 120 may generate a new message, data, command, or signal, based on the received message, data, command, or signal. The processor 120 may provide the processed or generated message, data, command, or signal to the performing object module 210, the scroll input module 220, the content summarization module 230, the scroll performing module 240, or the summary information module 250. The operations of the electronic device 101 of FIGS. 3 to 9 may be performed and controlled by the processor 120 of the electronic device 101.

An electronic device (for example, the electronic device 101) according to various embodiments described above may include a display (for example, the display device 160) and a processor (for example, the processor 120), and the processor may be configured to: display a first content from among a plurality of contents within a user interface in the display; identify a user input performed within the user interface; in response to the user input being identified, display a second content distinct from the at least one content displayed—a position of the first content within the user interface is scrolled by the identified user input-; identify information related to the first content and the second content; and, in response to the information being identified, display a visual object corresponding to the identified information within the user interface.

According to various embodiments, the processor (for example, the processor 120) may be configured to identify information included in the first content and the second content in common.

According to various embodiments, the processor (for example, the processor 120) may be configured to display the visual object corresponding to the identified information by overlapping with the user interface for displaying the second content.

According to various embodiments, the processor (for example, the processor 120) may be configured to: identify meta information of the first content or the second content; and identify the information related to the first content and the second content, based on the identified meta information.

An electronic device (for example, the electronic device 101) according to various embodiments described above may include: a touch screen display (for example, the display device 160); a wireless communication circuit (for example, the communication module 190); a processor (for example, the processor 120) operatively connected to the display and the communication circuit; and a memory (for example, the memory 130) operatively connected to the processor, and the memory may store instructions that, when being executed, cause the processor to: display a first part of a scrollable content on the display; receive a first gesture input for scrolling the content through the touch screen display; determine a second part of the content, based at least in part on the first gesture input; determine or extract a word, a phrase, a sentence, and/or a symbol associated with the determined second part, and display at least a part of the second part, and the word, phrase, sentence, and/or symbol on the display.

According to various embodiments, the instructions may cause the processor (for example, the processor 120) to: determine a first scroll speed for the content, based at least in part on the first gesture input; determine a first range including at least one content based on the first scroll speed; and determine the second part based at least in part on the first scroll speed.

According to various embodiments, the instructions may cause the processor (for example, the processor 120) to display the extracted word, phrase, or sentence on at least a part of the touch screen display (for example, the display device 160) while the content is being scrolled according to the first gesture input.

According to various embodiments, the instructions may cause the processor (for example, the processor 120) to: when a second gesture input for scrolling the screen at a second speed different from the first speed is received through the touch screen display (for example, the display device 160), determine a second range of the whole content that is different from the first range, and includes at least one content, based on the second speed; and extract a word, a phrase, or a sentence associated with the at least one content of the second range.

According to various embodiments, the instructions may cause the processor (for example, the processor 120) to display the extracted word, phrase, sentence, and/or symbol on a position of the touch screen display (for example, the display device 160) which is selected while the content is being scrolled.

According to various embodiments, the instructions may cause the processor (for example, the processor 120) to remove the display of the extracted word, phrase, or sentence from the screen after the scroll of the content is stopped.

FIG. 3A illustrates a flowchart 300-1 to explain an example of an electronic device for displaying visual objects indicating information related to a first content and a second content according to various embodiments.

Referring to FIG. 3A, in operation 301, a processor (for example, the processor 120 of FIG. 1) may display at least a first content of a plurality of contents. According to an embodiment, the processor 120 may display the first content of the plurality of contents within a user interface (UI) of a text message application, a chatting application, or a gallery application. The plurality of contents may include a conversation dialogue, a chatting dialogue, or a plurality of images. According to an embodiment, the processor 120 may display an object (for example, a scroll bar) for receiving an input of scrolling to display the plurality of contents along with the first content.

In operation 303, the processor 120 may identify a user input. According to an embodiment, the user input may include at least one of a swipe up/down input, a touch and drag input, a voice input, a gesture input, a contactless scroll input, a scroll input through a pen, an input through pupils. According to an embodiment, the user input may include a user input for discovering the plurality of contents. For example, the user input may include an input for converting into display of the second content while displaying the first content.

According to an embodiment, the processor 120 may identify that the user input starts from a first position of the display. The processor 120 may identify that the user input ends at a second position of the display. The processor 120 may identify a time from a start time of the user input to an end time. The processor 120 may identify a speed of the user input. According to an embodiment, the processor 120 may identify that user inputs are continuously received. The processor 120 may identify a time interval between the user inputs. For example, the processor 120 may identify that the user of the electronic device 101 iteratively performs a scroll input on the display of the electronic device 101. The processor 120 may identify a time interval between the scroll inputs.

In operation 305, in response to the user input being identified, the processor 120 may display the second content which is distinct from the at least one first content displayed. A position of the first content within the UI may be moved according to the identified user input. According to an embodiment, the processor 120 may determine the second content to be displayed, based on the speed of the user input or the time interval between the user inputs. According to an embodiment, the processor 120 may perform more scroll operations on the screen as the speed of the user input is faster or the time interval between the user inputs is shorter, and may determine the second content to be displayed. According to an embodiment, the processor 120 may perform less scroll operations on the screen as the speed of the user input is slower or the time interval between the user inputs is larger, and may determine the second content to be displayed. The processor 120 may display the determined second content within the user interface. According to an embodiment, the processor 120 may not display the first content within the user interface by performing the scroll operation on the first content when displaying the second content. According to an embodiment, the processor 120 may display the first content within the user interface by performing the scroll operation on the first content when displaying the second content. For example, in response to a user's downward scroll input being received, the processor 120 may display the first content on a lower end of the user interface, and may display the second content on an upper end of the user interface.

In operation 307, the processor 120 may identify information related to the first content and the second content. According to an embodiment, the processor 120 may identify information related to a content between the first content and the second content, in addition to the first content and the second content.

According to an embodiment, the processor 120 may identify information included in the content. The information included in the content may include information regarding what may define a person, a place, a thing, an event, or a concept. For example, when the content is a text, the processor 120 may identify a subject or an object corresponding to a noun such as subjects or objects from the information included in the content. According to an embodiment, when the first content and the second content are a part of a dialogue, a relationship between a word (or a keyword) included in the first content and a word (or a keyword) included in the second content may be extracted. For example, when the first content is a conversation content such as “Let's go riding a bike.” and the second content is a conversation content such as “Let's meet at 2 o'clock,” the processor 120 may extract “bike” from the first content and may extract “2 o'clock” from the second content. The processor 120 may identify that “bike” is an object of a behavior and “2 o'clock” is a time. According to an embodiment, the processor 120 may extract a relationship between information included in the first content and information included in the second content. According to an embodiment, the relationship between the information included in the first content and the information included in the second content may include an inclusion relationship in position between things. According to an embodiment, the relationship between the information included in the first content and the information included in the second content may include a family relationship or a friendship between persons.

According to an embodiment, the processor 120 may identify importance of the content. The processor 120 may identify text summarization, a paragraph structure. The processor 120 may identify the importance of the content through an attention algorithm. The processor 120 may identify importance of each of the plurality of contents. According to an embodiment, the operation of identifying the importance of the plurality of contents may be performed in a background of the electronic device 101.

According to an embodiment, the processor 120 may identify information related to the first content and the second content. According to an embodiment, the processor 120 may perform an extractive method or an abstractive method to identify the information related to the first content and the second content. For example, when the extractive method is performed, the processor 120 may spot an important keyword from the first content or the second content, and may identify the information related to the first content and the second content. In another example, when the abstractive method is performed, the processor 120 may parse a meaning based on the first content or the second content, and may identify the information related to the first content and the second content. According to an embodiment, the processor 120 may identify the information related to the first content and the second content in a compressed form by collapsing various modal internal data. For example, when the first content includes a meal preparing sound and the second content includes a meal sound, the processor 120 may identify the information related to the first content and the second content as a meal time. According to an embodiment, the processor 120 may identify the information related to the first content and the second content in a compressed form by collapsing multi-modal. For example, when the first content includes a meal preparing sound and the second includes an image of food on a table, the processor 120 may identify the information related to the first content and the second content as a meal time.

According to an embodiment, operation 307 is illustrated as being performed after the user input is received, but the processor 120 may perform operation 307 in the background of the electronic device 101 even when there is no user input.

In operation 309, the processor 120 may display visual objects corresponding to the identified information within the user interface, in response to the information related to the first content and the second content being identified. According to an embodiment, the processor 120 may display the information related to the first content and the second content within the user interface in the form of a visual object while displaying the second content. According to an embodiment, the processor 120 may display the information related to the first content and the second content within the user interface in the form of a pop-up window. According to an embodiment, the processor 120 may display the information related to the first content and the second content within the user interface in the form of a pop-up window in response to the user input being held. According to an embodiment, the processor 120 may display visual objects indicating the information related to the first content and the second content by overlapping with at least a part of the plurality of contents while displaying the at least part of the plurality of contents. According to an embodiment, the processor 120 may maintain the visual objects indicating the information related to the first content and the second content for a designated time. The processor 120 may maintain the visual objects indicating the information related to the first content and the second content for the designated time, and then may fade out. According to an embodiment, the processor 120 may display the visual objects indicating the information related to the first content and the second content in response to the user input being held.

FIG. 3B illustrates a flowchart 300-2 to explain an example of the electronic device for displaying a part of a content according to various embodiments.

Referring to FIG. 3B, in operation 310, the processor (for example, the processor 120 of FIG. 1) may display a first part of a scrollable content through a display device (for example, the display device 160 of FIG. 1) (for example, a display, a touch screen display) of the electronic device (for example, the electronic device 101 of FIG. 1). According to an embodiment, the processor 120 may display the first part of the content within a user interface of a text message application, a chatting application, or a gallery application. For example, the processor 120 may display a part of a chatting dialogue through the display device 160.

In operation 330, the processor 120 may receive a first gesture input for scrolling the content. According to an embodiment, the first gesture input may include at least one of a swipe up/down input, a touch and drag input, a voice input, a gesture input, a contactless scroll input, a scroll input through a pen, or an input through pupils.

In operation 350, the processor 120 may determine a second part of the content based at least in part on the first gesture input. According to an embodiment, the processor 120 may identify that the first gesture input starts from a first position. The processor 120 may identify that the first gesture input ends at a second position. According to an embodiment, the processor 120 may identify a speed (first scroll speed) of the first gesture input in response to the first gesture input starting from the first position and ending at the second position (based at least in part on the first gesture input). The processor 120 may determine the second part of the content based on the speed of the first gesture input. For example, the processor 120 may identify a second part of a chatting dialogue to be displayed, based on a first gesture input in a first part of the chatting dialogue. For example, the processor 120 may display a chatting record of 25 May of the chatting dialogue. The processor 120 may identify a chatting record of 26 May of the chatting dialogue based on the first gesture input. The processor 120 may determine the chatting record of 26 May of the chatting dialogue as the second part to be displayed through the display device 160.

In operation 370, the processor 120 may determine or extract a word, a phrase, a sentence, and/or a symbol associated with the determined second part. According to an embodiment, the processor 120 may determine or extract the word, phrase, sentence, and/or symbol by summarizing the second part of the content. For example, the processor 120 may identify a second part in an image application including a plurality of images. The processor 120 may determine or extract a word, a phrase, a sentence, and/or a symbol by summarizing the plurality of images included in the second part in the image application. For example, the processor 120 may identify that the plurality of images included in the second part in the image application are images related to a thesis representation. The processor 120 may determine a keyword (for example, a word, a phrase, a sentence, or a symbol) as “thesis representation” by summarizing the plurality of images included in the second part.

The processor 120 may receive a second gesture input for scrolling the content. According to an embodiment, the second gesture input may be inputted at a second speed different from a first speed of the first gesture input. The second gesture input may be to scroll the content at the second speed. When the second gesture input is received, the processor 120 may determine a second range of all of the contents, based on the second speed of the second gesture input. The processor 120 may determine or extract an associated word, phrase, sentence, and/or symbol by summarizing at least one content of the second range.

In operation 390, the processor 120 may display at least a part of the second part of the content and the word, phrase, sentence, and/or symbol associated with the second part of the content through the display device 160 (for example, the display, the touch screen display). According to an embodiment, the processor 120 may display the at least part of the second part of the content and the word, phrase, sentence, and/or symbol associated with the second part of the content through a visual object. According to an embodiment, the processor 120 may hold display of the visual object for a designated time. The processor 120 may hold the display of the visual object for the designated time and then may remove the display of the visual object. For example, the processor 120 may hold the display of the visual object for the designated time and then may fade out. According to an embodiment, the processor 120 may display the visual object through at least a part of the display device 160 (for example, the display, the touch screen display) while the content is being scrolled according to the first gesture input. The processor 120 may display the visual object at a designated position or a selected position while the content is being scrolled. After the scrolling of the content is stopped, the processor 120 may remove the display of the visual object. According to an embodiment, the processor 120 may display the visual object while the first gesture input is being held.

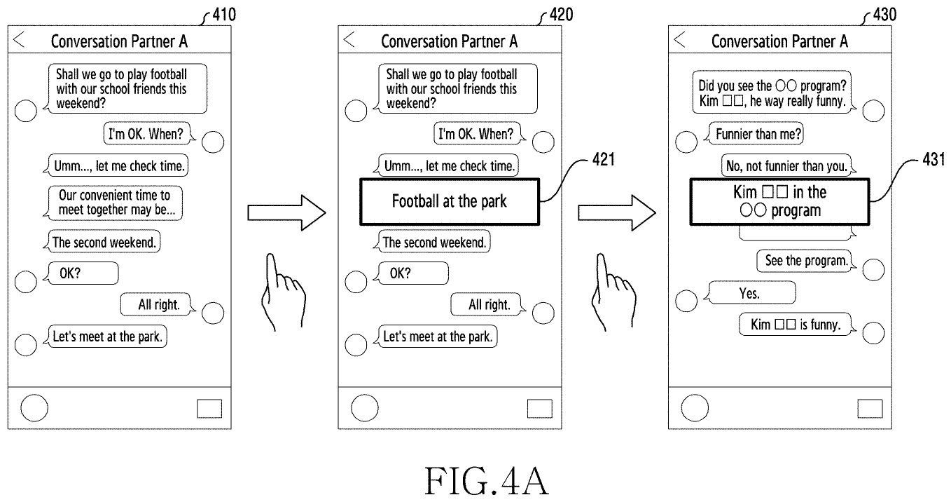

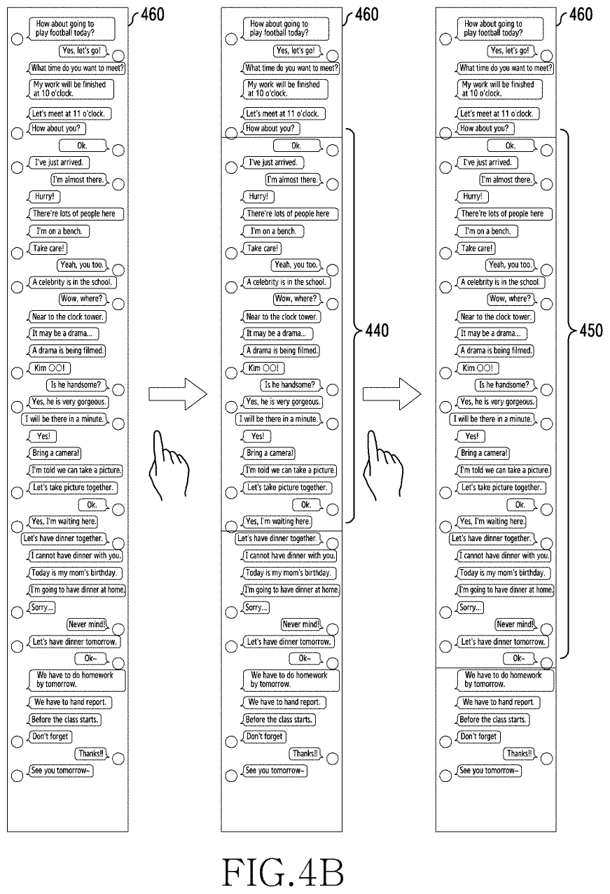

FIG. 4A illustrates an example of a user interface of an electronic device according to various embodiments.

Referring to FIG. 4A, the processor 120 may display a user interface 410 including a plurality of contents (for example, a conversation dialogue) through a messenger application. The processor 120 may display a first content of the plurality of contents within the user interface 410. According to an embodiment, the first content may include a first conversation such as “Shall we go to play football with our school friends this weekend?”

According to an embodiment, the processor 120 may receive a first user input. The first user input may include at least one of a swipe up/down input, a touch and drag input, a voice input, a gesture input, a contactless scroll input, a scroll input through a pen, and an input through pupils.

According to an embodiment, the processor 120 may determine a second content to be displayed based on the user input. According to an embodiment, the processor 120 may display the determined second content through a user interface 420. For example, the second content may include a second conversation such as “Let's meet at the park.” According to an embodiment, the processor 120 may determine the second content to be displayed, based on a speed or a direction of the user input. For example, the processor 120 may receive a swipe up input of a high speed through the user interface 410. The processor 120 may determine the second conversation which follows the first conversation to be displayed. The processor 120 may display the second conversation in the user interface 420.

According to an embodiment, the processor 120 may identify information related to the first content and the second content. According to an embodiment, the processor 120 may identify information related to a content between the first content and the second content, in addition to the information related to the first content and the second content. According to an embodiment, the processor 120 may identify the keywords “weekend,” “football,” “school friends” from the first content. The processor 120 may identify the keyword “park” from the second content. The processor 120 may identify the information related to the first content and the second content based on the identified keywords “weekend,” “football,” “school friends,” or “park.” The processor 120 may identify “football at the park” as the information related to the first content and the second content.

According to an embodiment, the processor 120 may display a visual object 421 indicating the information related to the first content and the second content within the user interface 420. According to an embodiment, in response to the first user input, the processor 120 may display the visual object 421 indicating the information related to the first content and the second content within the user interface 420. According to an embodiment, in response to the first user input being held, the processor 120 may display the visual object 421 indicating the information related to the first content and the second content within the user interface 420. According to an embodiment, the processor 120 may display the visual object 421 indicating the information related to the first content and the second content by overlapping with the plurality of contents displayed within the user interface 420. According to an embodiment, the processor 120 may maintain the visual object 421 indicating the information related to the first content and the second content for a designated time. According to an embodiment, the processor 120 may maintain the visual object 421 indicating the information related to the first content and the second content for the designated time, and then may fade out.

According to an embodiment, the processor 120 may receive a second user input. The processor 120 may identify a third content displayed in response to the second user input. The third content may include a third conversation such as “Did you see the ∘∘ program? Kim □□, he way really funny.” The processor 120 may identify a fourth content finally displayed based on the second user input. The fourth content may include a fourth conversation such as “Kim □□ is funny˜.” According to an embodiment, the processor 120 may identify the keywords “∘∘ program” or “Kim □□” from the third content. The processor 120 may identify the keyword “Kim □□” from the fourth content. The processor 120 may identify information related to the third content and the fourth content based on the identified keywords “∘∘ program” or “Kim □□.” The processor 120 may identify “Kim □□ in the ∘∘ program” as the information related to the third content and the fourth content. According to an embodiment, the processor 120 may display a visual object 431 indicating the information related to the third content and the fourth content within a user interface 430.

FIG. 4B illustrates a view to explain a range for obtaining information related to a content according to a user input in an electronic device according to various embodiments.

Referring to FIG. 4B, the processor 120 may identify a dialogue 460 including a plurality of contents. The processor 120 may display a content before a first area 440. According to an embodiment, the processor 120 may receive a first user input of swiping down. The processor 120 may identify that the first user input starts from a first position. The processor 120 may identify that the first user input ends at a second position. The processor 120 may identify a time from a start time of the first user input to an end time. The processor 120 may identify a speed of the first user input. The processor 120 may scroll and display the first area 440 based on the first user input. According to an embodiment, the processor 120 may identify information related to a content included in the first area 440. For example, the processor 120 may extract a keyword from the conversation included in the first area 440. The processor 120 may identify keyword information based on the keyword extracted from the first area 440. The processor 120 may display a visual object indicating the identified keyword within a user interface of the electronic device 101.

According to an embodiment, the processor 120 may receive a second user input which is distinct from the first user input and is faster than the first user input. The processor 120 may scroll and display a second area 450 based on the second user input. According to an embodiment, the processor 120 may identify information related to contents included in the second area 450. For example, the processor 120 may extract a keyword from a conversation included in the second area 450. The processor 120 may identify keyword information based on the keyword extracted from the second area 450. The processor 120 may display a visual object indicating the identified keyword within the user interface of the electronic device 101.

According to an embodiment, the processor 120 may set an area for extracting information related to contents to be wide, based on the user input being received fast. According to an embodiment, the processor 120 may set the area for extracting the information related to the contents to be narrow, based on the user input being received slow.

According to an embodiment, the processor 120 may set the area for extracting the information related to the contents to be wide, based on the user inputs being continuously received and being received at short time intervals. According to an embodiment, the processor 120 may set the area for extracting the information related to the contents to be narrow, based on the user inputs being continuously received and being received at long time intervals.

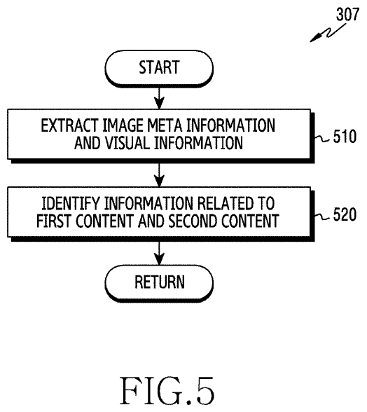

FIG. 5 illustrates an example of an operation for identifying information related to a first content and a second content in an electronic device according to various embodiments. Operations 510 to 520 of FIG. 5 may be related to operation 307 of FIG. 3.

Referring to FIG. 5, in operation 510, the processor 120 may extract image meta information and visual information from a first content or a second content. The first content or second content may include a multimedia content including a photo or a video. The first content or the second content may include image meta information. According to an embodiment, the image meta information may include information indicating a shooting place, a shooting date, a shooting time, or a shooting temperature. According to an embodiment, the processor 120 may identify the visual information by parsing an image from the first content or the second content. For example, the processor 120 may identify information regarding a shooting object, face recognition by parsing an image from a first photo or a second photo.

In operation 520, the processor 120 may identify information related to the first content and the second content. Operation 520 may correspond to operation 307 of FIG. 3A. The processor 120 may identify the information related to the first content and the second content, based on the image meta information and the visual information of the first content or the second content. For example, the processor 120 may identify summary information based on a shooting place of the first content, a shooting time or shooting object of the second content.

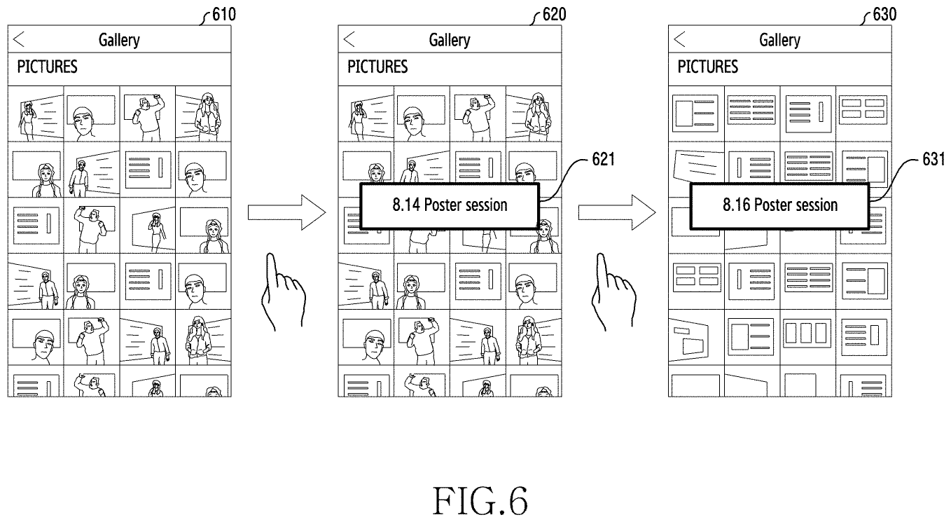

FIG. 6 illustrates another example of a user interface of an electronic device according to various embodiments.

Referring to FIG. 6, the processor 120 may display a list of photos from a gallery application through a user interface 610. The processor 120 may receive a first user input while displaying the user interface 610. The processor 120 may determine a position to be scrolled and displayed in response to the first user input.

According to an embodiment, the processor 120 may identify visual information by parsing an image. The processor 120 may extract image meta information and visual information of at least a part of the plurality of photos displayed on the user interface 610 or a user interface 620. The processor 120 may identify that at least a part of the plurality of photos corresponds to a photo related to a poster session. The processor 120 may display a visual object 621 indicating that a plurality of photos are related to the poster session within the user interface 620.

According to an embodiment, the processor 120 may receive a second user input. In response to the second user input, the processor 120 may determine a position to be scrolled and displayed. In response to the second user input, the processor 120 may display a user interface 630. The processor 120 may extract image meta information and visual information of at least a part of the plurality of photos displayed on the user interface 630. The processor 120 may identify that at least a part of the plurality of photos displayed on the user interface 630 is a photo related to a presentation. The processor 120 may display a visual object 631 indicating that the plurality of photos displayed on the user interface 630 are related to the presentation within the user interface 630.

According to an embodiment, the processor 120 may extract meta information and visual information of a plurality of images stored in the electronic device 101 regardless of a user input. The processor 120 may classify the plurality of images into at least one group, based on the meta information and the visual information of the plurality of images. The processor 120 may determine information (for example, summary information, keyword information) related to at least one image included in the at least one group, and may store the information along with the at least one group. The processor 120 may display a visual object indicating information related to the at least one image included in the at least one group when the at least one group is displayed in response to a user input being received.

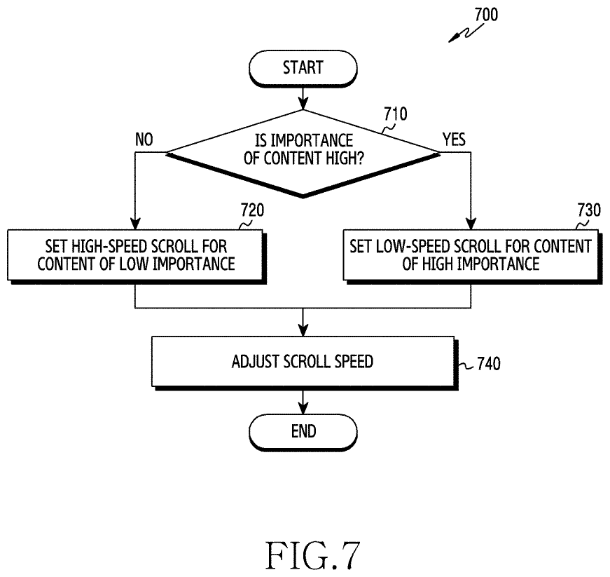

FIG. 7 illustrates a flowchart 700 for adjusting a scroll speed according to importance of a content in an electronic device according to various embodiments.

Referring to FIG. 7, in operation 701, the processor 120 may identify importance of a content, and may adjust a scroll speed according to a degree of importance. For example, the processor 120 may identify importance of a plurality of contents included in a dialogue. In another example, the processor 120 may identify importance of a plurality of images included in a list of photos stored in the electronic device 101.

According to an embodiment, the processor 120 may identify importance by using an attention algorithm. The processor 120 may identify importance of the content, based on environmental information of the electronic device 101. For example, the processor 120 may identify that the user of the electronic device 101 holds display of at least a part of the plurality of contents for a long time. The processor 120 may identify that importance of at least a part of the plurality of contents that is displayed for the long time is high. In another example, the processor 120 may store a keyword searched by the user of the electronic device 101. The processor 120 may identify that importance of a content related to the keyword searched by the user from among the plurality of contents is high.

According to an embodiment, the processor 120 may display that the importance of the content is high, based on the importance of the content being identified. For example, the processor 120 may change a border of an object indicating a content of high importance to be thicker than a border of an object indicating a content of low importance, and may display the object. In another example, the processor 120 may further display a star-like object indicating display of importance beside the object indicating the content of high importance. In still another example, the processor 120 may change color, a font type, a size of the content of high importance, or may add a special effect (for example, a blinking effect).

In operation 720, the processor 120 may set a high-speed scroll for the content identified as having low importance from among the plurality of contents. According to an embodiment, the processor 120 may set a high-speed scroll operation to be performed even in response to the same user input when the content of low importance is displayed from among the plurality of contents. According to an embodiment, the processor 120 may set the high-speed scroll operation to be performed in an area including the content of low importance from among the plurality of contents.

In operation 730, the processor 120 may set a low-speed scroll for the content identified as having high importance from among the plurality of contents. According to an embodiment, when the content of high importance is displayed from among the plurality of contents, the processor 120 may set a low-speed scroll operation to be performed despite of the same user input. According to an embodiment, the processor 120 may set the low-speed scroll operation to be performed in an area including the content of high importance from among the plurality of contents.

In operation 740, the processor 120 may adjust a scroll speed according to each content, based on the scroll speed set in operations 720 and 730. The processor 120 may adjust the scroll speed by using the scroll execution unit 242, based on a user input for scrolling the plurality of contents being received.

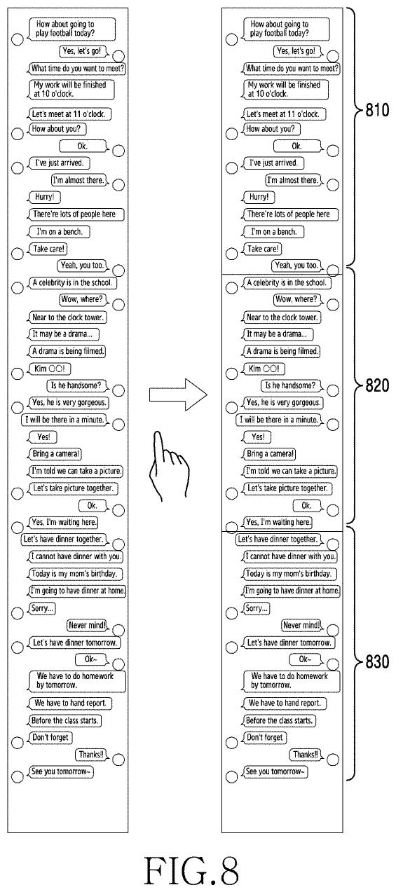

FIG. 8 illustrates another example of the operation of adjusting a scroll speed according to importance of a content according to various embodiments.

Referring to FIG. 8, the processor 120 may identify a dialogue including a plurality of contents. The processor 120 may identify importance of each of the plurality of contents. For example, the processor 120 may identify an area including a usual conversation in the dialogue. The processor 120 may identify an area including a conversation other than the usual conversation. According to an embodiment, the processor 120 may identify a content of high importance from among the plurality of contents through an algorithm for determining importance. The processor 120 may identify a content of low importance from among the plurality of contents through the algorithm for determining importance. The processor 120 may identify an area including the content of high importance. The processor 120 may identify an area including the content of low importance.

According to an embodiment, the processor 120 may identify an area 810 or an area 830 including a content of low importance. The processor 120 may identify an area 820 including a content of high importance. In response to the same user input, the processor 120 may perform a high-speed scroll in the area 810 or the area 830. In response to the same user input, the processor 120 may perform a low-speed scroll in the area 820. The processor 120 may change or adjust the scroll speed to scroll the plurality of contents at different speeds in response to the same user input.

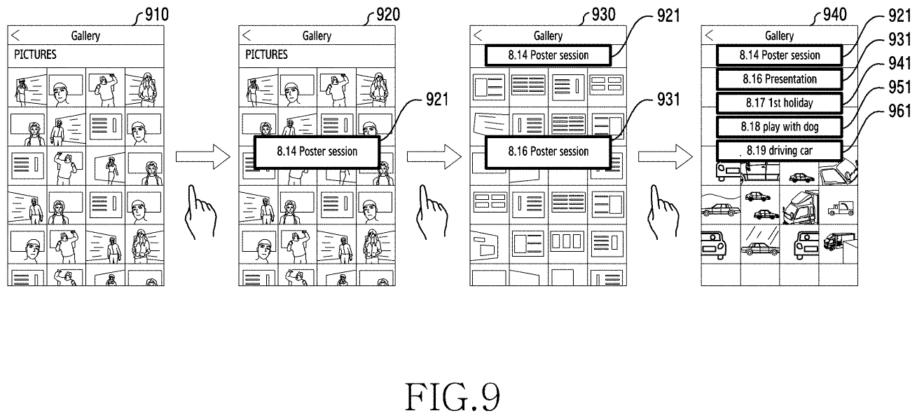

FIG. 9 illustrates another example of a user interface of an electronic device according to various embodiments. Referring to FIG. 9, the processor 120 may display a list of photos through a user interface 910 in a gallery application. The processor 120 may receive a first user input while displaying the user interface 910. The processor 120 may scroll the list of photos and may determine photos to be displayed through the user interface 910, in response to the first user input.

According to an embodiment, the processor 120 may identify visual information by parsing an image. The processor 120 may extract image meta information and visual information of at least a part of the plurality of photos displayed in the user interface 910 or a user interface 920. The processor 120 may identify that at least a part of the plurality of photos corresponds to a photo related to a poster session shot on 14 August. The processor 120 may display a visual object 921 indicating that the plurality of photos are related to the poster session shot on 14 August within the user interface 920.

According to an embodiment, the processor 120 may receive a second user input. The processor 120 may scroll the list of photos and may determine photos to be displayed in response to the second user input. The processor 120 may display a user interface 930 in response to the second user input. The processor 120 may extract image meta information and visual information of at least a part of the plurality of photos displayed on the user interface 930. The processor 120 may identify that at least a part of the plurality of photos displayed on the user interface 930 corresponds to a photo related to a presentation shot on 16 August. The processor 120 may display a visual object 931 indicating that the plurality of photos displayed on the user interface 930 are related to the presentation shot on 16 August within the user interface 930. According to an embodiment, the processor 120 may shift the position of the visual object 921 to an upper end of the user interface 930, and may maintain the display. In response to a user input on the visual object 921 being received, the processor 120 may scroll the screen to the user interface 920 and may display the user interface 920.

According to an embodiment, the processor 120 may receive continuous user inputs. The processor 120 may accumulate a visual object 941, a visual object 951, and a visual object 961 and display the objects similarly to the user interface which is changed according to a second user input. According to an embodiment, in response to a user input of selecting one of the plurality of visual objects 921, 931, 941, 951, 961 being received, the processor 120 may scroll and display at least one photo related to the selected visual object. For example, the processor 120 may receive an input on the visual object 951 in the user interface 940. Based on the input on the visual object 951 being received, the processor 120 may display a photo shot with a puppy on 18 August, which is related to the visual object 951.

According to an embodiment, the processor 120 may extract meta information and visual information of the plurality of images stored in the electronic device 101 regardless of a user input. The processor 120 may classify the plurality of images into at least one group, based on the meta information and the visual information of the plurality of images. The processor 120 may determine information (for example, summary information, keyword information) related to at least one image included in the at least one group, and may store the information along with the at least one group. According to an embodiment, the processor 120 may display a part of the plurality of images and may display a visual object indicating information related to the at least one image included in the at least one group, along with the user interface 940.

A method of an electronic device (for example, the electronic device 101) according to various embodiments described above may include: displaying a first content from among a plurality of contents within a user interface in a display of the electronic device; identifying a user input performed within the user interface; in response to the user input being identified, displaying a second content distinct from the at least one content displayed—a position of the first content within the user interface is scrolled by the identified user input; identifying information related to the first content and the second content; and, in response to the information being identified, displaying a visual object corresponding to the identified information within the user interface.

According to various embodiments, identifying the information related to the first content and the second content may include identifying information included in the first content and the second content in common.

According to various embodiments, displaying the visual object corresponding to the identified information within the user interface may include displaying the visual object corresponding to the identified information by overlapping with the user interface for displaying the second content.

According to various embodiments, identifying the information related to the first content and the second content may include: identifying meta information of the first content or the second content; and identifying the information related to the first content and the second content, based on the identified meta information.

According to various embodiments, the method may further include maintaining the display of the visual object, and displaying a third content in response to a second user input being identified.

According to various embodiments, the method may further include, in response to a third user input on the visual object being identified, scrolling from the third content to the second content and displaying the second content.

According to various embodiments, the method may further include: identifying importance of at least some contents of the plurality of contents; and, based on the importance of the at least some contents of the plurality of contents, adjusting a scroll speed for searching the plurality of contents.

According to various embodiments, adjusting the scroll speed for searching the plurality of contents based on the importance of the at least some contents of the plurality of contents may include: identifying that the importance of the at least some contents of the plurality of contents is high; and setting a scroll speed of an area including the contents of high importance to be slow.

According to various embodiments, the user input may include at least one of a swipe up/down input, a touch and drag input, a voice input, a gesture input, a contactless scroll input, a scroll input through a pen, and an input through user's pupils.

According to various embodiments, the first content or the second content may include a multimedia content.

According to various embodiments, the electronic device can display a visual object related to a content.

According to various embodiments, the electronic device can display a visual object related to at least a part of a plurality of contents.

According to various embodiments, the electronic device can display an object representing at least a plurality of contents according to a user input.

According to various embodiments, the electronic device can display a visual object related to contents of a range determined based on a user input.

According to various embodiments, the electronic device can display an object representing contents of a range determined based on a user input.

The effects achieved by the disclosure are not limited to those mentioned above, and other effects that are not mentioned above may be clearly understood to those skilled in the art based on the description provided above.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of an electronic device, the method comprising:
displaying a first content from among a plurality of contents within a user interface in a display of the electronic device;
identifying a user input performed within the user interface;
in response to the user input being identified, displaying a second content distinct from the first content displayed;
identifying information related to the first content and the second content; and
in response to the information being identified, displaying a visual object corresponding to the identified information within the user interface.

2. The method of claim 1, wherein identifying the information related to the first content and the second content comprises identifying information included in the first content and the second content in common.

3. The method of claim 1, wherein displaying the visual object corresponding to the identified information within the user interface comprises displaying the visual object corresponding to the identified information by overlapping with the user interface for displaying the second content.

4. The method of claim 1, wherein identifying the information related to the first content and the second content comprises:
identifying meta information of the first content or the second content; and
identifying the information related to the first content and the second content based on the identified meta information.

5. The method of claim 1, further comprising:
maintaining the display of the visual object; and
displaying a third content in response to a second user input being identified.

6. The method of claim 5, further comprising, in response to a third user input on the visual object being identified:
scrolling from the third content to the second content; and
displaying the second content.

7. The method of claim 1, further comprising:
identifying importance of at least some contents of the plurality of contents; and
based on the importance of the at least some contents of the plurality of contents, adjusting a scroll speed for searching the plurality of contents.

8. The method of claim 7, wherein adjusting the scroll speed for searching the plurality of contents based on the importance of the at least some contents of the plurality of contents comprises:
identifying that the importance of the at least some contents of the plurality of contents is high; and
setting a scroll speed of an area comprising the contents of high importance to be slow.

9. The method of claim 1, wherein the user input comprises at least one of a swipe up/down input, a touch and drag input, a voice input, a gesture input, a contactless scroll input, a scroll input through a pen, and an input through user's pupils.

10. The method of claim 1, wherein the first content or the second content comprises a multimedia content.

11. An electronic device comprising:
a display; and
a processor,
wherein the processor is configured to:
display a first content from among a plurality of contents within a user interface in the display;
identify a user input performed within the user interface;
in response to the user input being identified, display a second content distinct from the first content displayed;
identify information related to the first content and the second content; and
in response to the information being identified, display a visual object corresponding to the identified information within the user interface.

12. The electronic device of claim 11, wherein the processor is further configured to identify information included in the first content and the second content in common.

13. The electronic device of claim 11, wherein the processor is further configured to display the visual object corresponding to the identified information by overlapping with the user interface for displaying the second content.

14. The electronic device of claim 11, wherein the processor is further configured to:
identify meta information of the first content or the second content; and
identify the information related to the first content and the second content based on the identified meta information.

15. An electronic device comprising:
a touch screen display;
a wireless communication circuit;
a processor operatively connected to the display and the wireless communication circuit; and
a memory operatively connected to the processor,
wherein the memory stores instructions that, when being executed, cause the processor to:
display a first part of a scrollable content on the display;
receive a first gesture input for scrolling the content through the touch screen display;
determine a second part of the content based at least in part on the first gesture input;
determine or extract a word, a phrase, a sentence, or a symbol associated with the determined second part, and
display at least a part of the second part and the word, phrase, sentence, or symbol on the display.

16. The electronic device of claim 15, wherein the instructions further cause the processor to:
determine a first scroll speed for the content based at least in part on the first gesture input;
determine a first range including at least one content based on the first scroll speed; and
determine the second part within the first range based at least in part on the first scroll speed.

17. The electronic device of claim 16, wherein the instructions further cause the processor to display the extracted word, phrase, sentence, or symbol on at least a part of the touch screen display while the content is being scrolled according to the first gesture input.

18. The electronic device of claim 16, wherein, when a second gesture input for scrolling the screen at a second scroll speed different from the first scroll speed is received through the touch screen display, the instructions further cause the processor to:
determine a second range of a whole content that is different from the first range based on the second scroll speed, the second range comprising at least one content; and
extract a word, a phrase, or a sentence associated with the at least one content of the second range.

19. The electronic device of claim 18, wherein the instructions further cause the processor to remove the display of the extracted word, phrase, or sentence from the screen after the scroll of the content is stopped.

20. The electronic device of claim 16, wherein the instructions further cause the processor to display the extracted word, phrase, sentence, or symbol on a position of the touch screen display which is selected while the content is being scrolled.
